(19) United States
(12) Patent Application Publication
(10) Pub. No.: US 2026/0365108 A1
(43) Pub. Date: Nov. 19, 2026

(54) MAST-MOUNTED ENHANCED VISIBILITY SYSTEM

(71) Applicant: Toyota Material Handling, Inc., Columbus, IN (US)

(72) Inventors: Mona Jalal, Columbus, IN (US); Joshua G. Linnemann, Columbus, IN (US); Maitry Harshel Naik, Columbus, IN (US); Victor Matthew Penrod, Columbus, IN (US); Anthony Brian Simpson, Columbus, IN (US); Maria Sabbagh, Columbus, IN (US); Viet Truong Giang Nguyen, Columbus, IN (US); Thomas Louis Stemnock, Columbus, IN (US)

(21) Appl. No.: 19/676,097

(22) Filed: May 13, 2026

Related U.S. Application Data
(60) Provisional application No. 63/805,057, filed on May 13, 2025.

(51) Int. Cl. B60R 1/24; B66F 17/00

(52) U.S. Cl. CPC B60R 1/24; B66F 17/003; B60R 2300/101; B60R 2300/202; B60R 2300/306; B60R 2300/802

(57) ABSTRACT

A material handling vehicle is provided. The material handling vehicle includes a mast, a display, a camera, and a controller. The display is mounted to a rear side of the mast. The camera is in communication with the display. The controller is in communication with the camera and the display. The controller includes a processor and memory configured to display an image of an environment forward of the mast via the display.

### CROSS REFERENCE TO RELATED APPLICATIONS

This application claims priority to U.S. Provisional Patent Application No. 63/805,057, filed May 13, 2025, the entire disclosure of which is incorporated by reference herein.

### BACKGROUND

Material handling vehicles, such as forklifts, are often equipped with a mast to lift objects (e.g., pallets). The mast produces a blind spot with respect to an operator when the operator is seated in the material handling vehicle.

Conventional material handling systems and methods lack the ability to decrease blind spots and thus keep the material handling vehicle in service by avoiding obstacles.

### SUMMARY

This disclosure generally relates to material handling vehicles. More specifically, this disclosure relates to a field of view enhancement system and method for use with material handling vehicles.

Some embodiments provide a material handling vehicle including a mast, a display mounted to a rear side of the mast, a camera in communication with the display, and a controller in communication with the camera and the display, the controller including a processor and memory configured to display an image of an environment forward of the mast via the display.

In some embodiments, the processor and memory can be configured to adjust the image to align with the environment with respect to a field of view of an operator such that a size and shape of presented objects shown in the display are substantially similar to a size and shape of actual objects as they would appear to the operator if the operator had an unobstructed view of the actual objects in the environment.

In some embodiments, the processor and memory adjust the image based on one or more of an operator presence system output and a height of an operator seat.

In some embodiments, the processor and memory can adjust the image based on relative features identified within a plurality of image frames collected from image data of the camera.

In some embodiments, the material handling vehicle further includes at least one camera motor and a tilt sensor to measure a tilt angle of the mast, and the processor and memory are configured to level the camera via the at least one camera motor based on the tilt angle of the mast.

In some embodiments, the processor and memory are configured to level the camera after the mast is placed in a tilted position and stops moving.

In some embodiments, the processor and memory are configured to level the camera dynamically as the mast tilts.

In some embodiments, the processor and memory are configured to adjust the image based on a field of view offset value, and the field of view offset value is determined based on one or more of a height of an operator and a location of an eye of the operator relative to the mast.

In some embodiments, the processor and memory determine one or more of the height of the operator and the location of the eye of the operator via an operator sensor mounted within a cab.

In some embodiments, the field of view offset value includes one or more predetermined adjustment parameters including crop and zoom offsets, an image trapezoid offset, or operator height presets.

In some embodiments, the operator enters the height via one or more of a console and an accessory computing device in communication with the controller.

In some embodiments, the material handling vehicle further includes a carriage coupled to the mast, a carriage camera coupled to the carriage, and the carriage further includes a pair of forks, each fork including a fork tip.

In some embodiments, the carriage camera is positioned one of between the pair of forks or in one of the fork tips.

In some embodiments, the display is configured to show a picture-in-picture video feed of the carriage camera.

In some embodiments, the display is configured to show a live feed of one or more material handling vehicle parameters such as mast height, load weight, fork tip alignment status, pedestrian detection status, and vehicle speed.

In some embodiments, the processor and memory store one or more vehicle operation threshold values and are configured to show an alert on the display when the one or more vehicle operation threshold values are exceeded.

A method to mitigate blind spots for an operator of a material handling vehicle includes collecting images from a camera mounted to the material handling vehicle, the camera being oriented to look forward relative to a mast of the material handling vehicle, measuring one or more parameters of an operator aboard the material handling vehicle behind the mast, determining field of view offsets based on the measured one or more parameters, adjusting the images based on the field of view offsets, and presenting the adjusted images on a display mounted to an operator side of the mast.

The method further includes determining a tilt angle of the mast with a tilt sensor and leveling the camera with at least one camera motor based on the tilt angle.

The one or more parameters include a height of the operator and a location of an eye of the operator.

A material handling vehicle includes a mast, a display mounted to a rear side of the mast, an operator station behind the mast and the display, a camera in communication with the display, and a controller in communication with the camera and the display, the controller including a processor and memory configured to adjust an image from the camera of an environment forward of the mast and display the adjusted image via the display, the adjusted image providing an optical illusion to an operator seated in the operator station that the mast is transparent.

The processor and memory are configured to adjust the image based on one or more of a height of the operator, a location of an eye of the operator relative to the mast, and a field of view offset value.

### BRIEF DESCRIPTION OF DRAWINGS

The accompanying drawings, which are incorporated in and form a part of this specification, illustrate examples of the disclosure and, together with the description, serve to explain the principles of examples of the disclosure:

FIG. 1 is an isometric view of a material handling vehicle equipped with a field of view enhancement system, according to an example;

FIG. 2 is an overhead plan view of an operator seated in a cab, with the overhead guard removed for visibility, of the material handling vehicle of FIG. 1;

FIG. 3 is a side elevational view of an operator seated in the cab of the material handling vehicle of FIG. 1;

FIG. 4 is a forward-looking interior elevational view of the cab of FIG. 2 as viewed by the operator of the material handling vehicle of FIG. 3;

FIG. 5 is a block diagram of various aspects of the field of view enhancement system of FIG. 1; and

FIG. 6 is a flow diagram depicting a method to mitigate operator blind spots executable by the field of view enhancement system of FIG. 1, according to the principles of this disclosure.

### DETAILED DESCRIPTION

The following discussion is presented to enable a person skilled in the art to make and use examples of the disclosure. Various modifications to the illustrated examples will be readily apparent to those skilled in the art, and the generic principles herein may be applied to other examples and applications without departing from examples of the disclosure. Thus, examples of the disclosure are not intended to be limited to examples shown but are to be accorded the widest scope consistent with the principles and features disclosed herein. The following detailed description is to be read with reference to the figures, in which like elements in different figures have like reference numerals. The figures, which are not necessarily to scale, depict selected examples and are not intended to limit the scope of examples of the disclosure. Skilled artisans will recognize the examples provided herein have many useful alternatives and fall within the scope of examples of the disclosure.

Before any examples of the disclosure are explained in detail, it is to be understood that the disclosure is not limited in its application to the details of construction and the arrangement of components set forth in the following description or illustrated in the attached drawings. The disclosure is capable of other examples and of being practiced or of being carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

Turning now to an overview of the present disclosure, a field of view enhancement system improves visibility and mitigates blind spots for an operator of a material handling vehicle, which may improve overall safety, aid the operator in picking up loads, aid the operator in navigating a facility (e.g., a warehouse, facility, job site, etc.), increase operational efficiency, and/or reduce guesswork for the operator. More specifically, the field of view enhancement system includes one or more cameras and/or displays mounted to the material handling vehicle to provide views of objects beyond the masts of the material handling vehicle. In some instances, the cameras capture forward-looking video streams relative to the masts. In some aspects, the displays are integrated into the masts. Thus, the cameras and the displays may provide additional visibility of objects obscured by the masts relative to a field of view of an operator of the material handling vehicle.

One or more of the displays may also show parameters measured or monitored by the material handling vehicle (e.g., mast height, load weight, fork tip alignment relative to a target, pedestrian detection, speed, battery charge, etc.). The displays may additionally show vehicle data, error codes, emergency notifications, pedestrian identifications, etc. In some instances, one or more of the displays is a heads-up display and/or transparent. In some instances, the displays turn off in response to the mast extending to provide a view of objects directly behind the displays during a lift function. Further, the displays may be sized to be substantially the same width and height as the width and height of the mast to avoid creating additional visual obstruction.

The cameras may be mounted to front and/or side surfaces of the masts. Additionally, one or more of the cameras may be self-leveling or otherwise adjustable to compensate for mast tilt (e.g., forward or backward). In some non-limiting examples, the one or more cameras may be adjusted via a motor (e.g., a stepper motor), or other actuated controller that is actuated based on signals received from a tilt sensor mounted to the mast, or other sensor(s). In some examples, the one or more cameras may be adjusted manually. In some instances, the self-leveling camera initiates a leveling process once the mast is placed in a tilt position and stops moving. In some instances, the self-leveling camera levels dynamically as the mast tilts. In some instances, one or more additional cameras are mounted to the forks of the material handling vehicle. In this non-limiting example, images from these fork cameras may be shown picture-in-picture in the displays mounted to the masts and/or via a dedicated display. In some aspects, the system may include a tuning device to verify that the cameras and/or displays are adjusted appropriately based on a tilt angle and/or height to provide ergonomic visibility.

Further, in some instances, the cameras and displays are powered by and/or communicatively connected to a controller (e.g., via Ethernet, Controller Area Network (CAN), a power over Ethernet (PoE) switch, etc.). The controller may include memory and a processor (e.g., a graphics processing unit) and may implement an object detection protocol (e.g., YOLO), image adjustments, real-time object identification, augmented reality, simultaneous localization and mapping, object tracking, etc.

In some forms, the controller may process image adjustments, including but not limited to enhancing, cropping, and/or zooming image data supplied by the cameras. In some instances, the image adjustments are based on an operator’s overall height and/or location of the operator’s eyes within the material handling vehicle. In some instances, image adjustments are based on a field of view options selected by the operator. In some instances, image adjustments are made according to inputs made by the operator analogous to adjusting a mirror. Thus, the field of view enhancement system may generate an illusion to the operator that causes the front masts of the material handling vehicle to appear transparent.

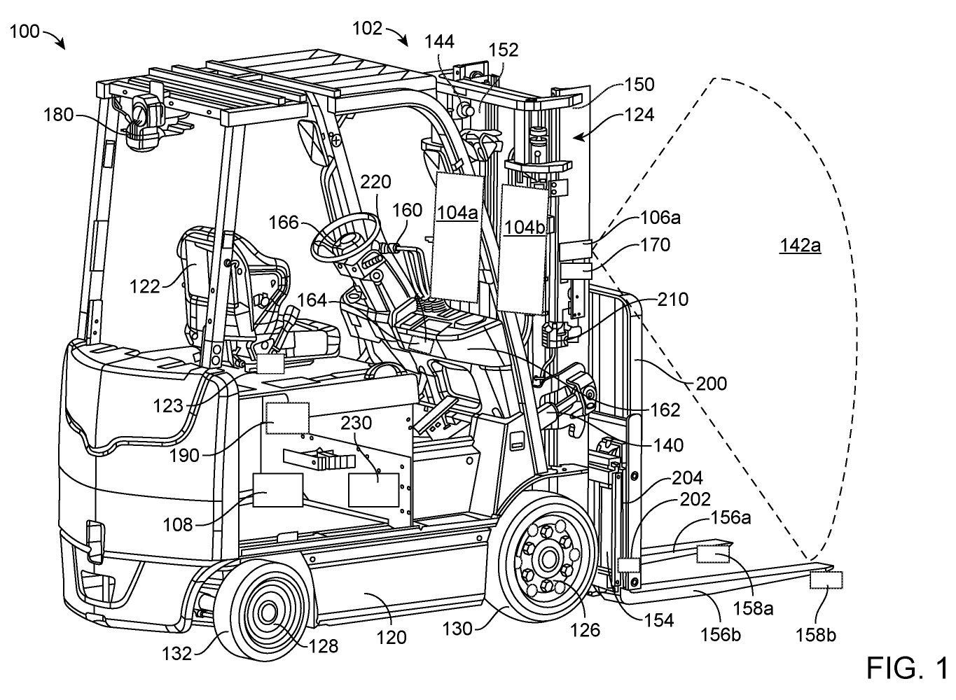

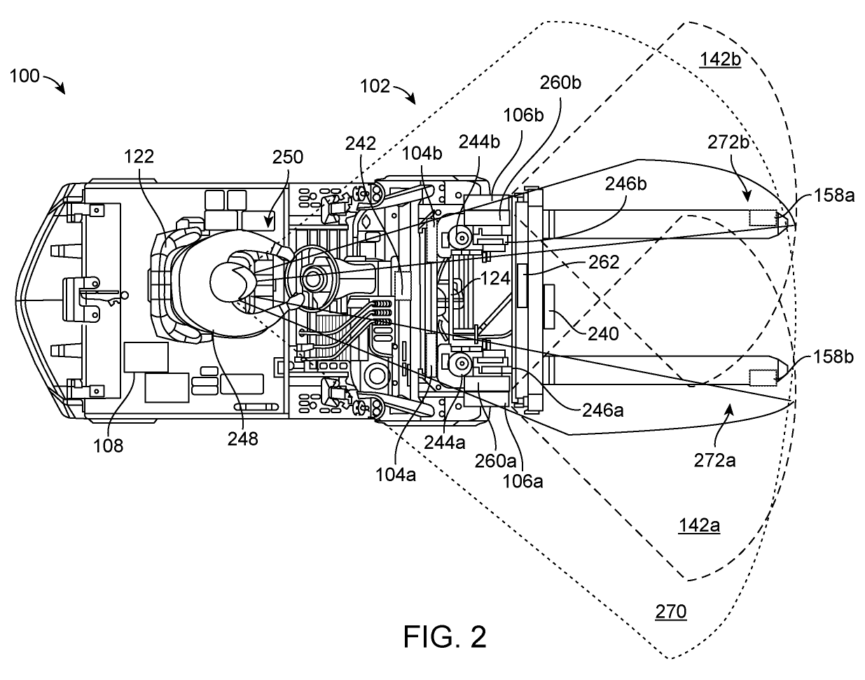

FIG. 1 illustrates an advanced material handling vehicle 100 equipped with a field of view enhancement system 102, according to an example. Specifically, an advanced material handling vehicle 100 provided in the form of a counterbalance type forklift truck is illustrated, although the systems and processes described herein may be applied to other types of material handling vehicles. The field of view enhancement system 102 further includes a first display 104a, a second display 104b, a first blind spot camera 106a, and a second blind spot camera 106b (see FIG. 2). Aspects of the field of view enhancement system 102 may be wired and/or wirelessly communicatively connected to a controller 108 (e.g., via CAN, Ethernet, etc.).

The material handling vehicle 100 may comprise a body 120 with an operator’s seat 122 provided at a front portion of the body 120. In some instances, the operator’s seat 122 is adjustable (e.g., horizontally, vertically, side-to-side, etc.) relative to the body 120. In some forms, the material handling vehicle 100 may include an operator presence system 123 such as a pressure switch or contact switch in the operator’s seat 122, a switch in a seatbelt latch, or the like. The operator presence system 123 can provide an output to the controller 108 to indicate a detected presence of an operator.

A mast 124 may be provided in front of the operator’s seat 122. The body 120 may further be connected to a set of wheels provided in the form of front wheels 126 and rear wheels 128, at a front portion and at a rear portion of the body 120, respectively. Depending on the examples, either the front wheels 126 may be used for steering the material handling vehicle 100 or the rear wheels 128 may be used for steering, or both sets of wheels may be used for four-wheel steering. In some examples, the wheels may be provided in the form of tracks or other forms of movable support for the material handling vehicle 100. In some examples, the wheels may include encoders, which may collect and process data related to the distance traveled by the material handling vehicle 100 or other parameters related to the forklift operation. Additionally, the front wheels 126 and the rear wheels 128 are respectively equipped with front tires 130 and rear tires 132.

The mast 124 may be supported on a front axle so that the mast 124 may be tiltable in a forward or a backward direction with respect to the body 120. The tilting of the mast 124 may be accomplished by using a tilt cylinder 140. The tilt cylinder 140 may retract or protract, thereby tilting the mast 124. The first blind spot camera 106a is forward-facing, mounted to the mast 124, and has a first camera field of view 142a. The primary displays 104a, 104bare rearward-facing and adjustably mounted to a rear side 144 of the mast 124.

In one example, the mast 124 may be a two-level slide mast that includes an outer mast 150 and an inner mast 152. The outer mast 150 may be supported on the body 120 in a tiltable manner, and the inner mast 152 may be supported on the outer mast 150 in a liftable manner. The inner mast 152 may further support a lift carriage 154 and forks 156a, 156b. Moreover, the outer mast 150 may be provided with one or more lift cylinders to lift or lower the inner mast 152 with the lift carriage 154 and the forks 156a, 156b. In some instances, each of the forks 156a, 156brespectively supports a fork tip camera 158a, 158b. It is to be understood that the material handling vehicle 100 may include other mast configurations, lifting devices, and load-carrying features.

One or more control levers 160 may be provided for controlling the material handling vehicle 100. While these control levers 160 are provided on a console 162 in the illustrated example of FIG. 1, it should be understood that the control levers 160 may be provided anywhere onboard the material handling vehicle 100 (e.g., seat armrest, a control panel, etc.). For example, the one or more control levers 160 may be used to shift the material handling vehicle 100 into forward or backward movements. The one or more control levers 160 may be coupled to a direction sensor 164, which may further be coupled to the controller 108 provided onboard the body 120. In an example, the direction sensor 164 may be designed to detect whether the material handling vehicle 100 is moving forward or moving backward vis-à-vis the position of the one or more control levers 160. Additionally, a steering controller 166 may be provided for controlling turning, maneuvering, and/or steering of the material handling vehicle 100. While this steering controller 166 is depicted as a steering wheel in the illustrated example of FIG. 1, it should be understood that the steering controller 166 may be provided as any type of maneuvering device (e.g., tiller, joystick, knob, etc.).

A forward sensor 170 may be provided in front of the material handling vehicle 100. The forward sensor 170 may be a data capture device like an individual sensor, or a collection of sensors that may include, for example, one or more laser scanners, accelerometers, gyro sensors, proximity sensors, radars, lidars, optical sensors, acoustic sensors, barometers, thermometers, and/or other suitable sensors. The forward sensor 170 may also be communicatively, electrically, and/or otherwise connected to the controller 108. In some instances, the forward sensor 170 is included in and/or integral with the camera 106a.

The forward sensor 170 may be designed to detect conditions in front of the material handling vehicle 100, such as the presence of an obstacle. By way of example, the forward sensor 170, together with the controller 108, may sense various parameters corresponding to the surrounding environment and determine that the material handling vehicle 100 is approaching a pallet, an object, a person, or an environmental condition or hazard (e.g., a step, a stair, a dock door, etc.). In some examples, the forward sensor 170 may be mounted at a location on the material handling vehicle 100 so that it may supplement a field of view of an operator, whose field of view may be obstructed when the material handling vehicle 100 is carrying a load.

The material handling vehicle 100 may further include a backward sensor 180. Similar to the forward sensor 170, the backward sensor 180 may be provided in the form of a data capture device such as an individual sensor, or a collection of sensors, including, but not limited to, one or more cameras, laser scanners, accelerometers, gyro sensors, proximity sensors, radars, lidars, optical sensors (e.g., infrared sensors, photodiodes, image sensors, etc.), acoustic sensors, barometers, thermometers, and/or other suitable sensors. The backward sensor 180 may similarly be communicatively, electrically, and/or otherwise connected to the controller 108.

The backward sensor 180 may likewise be designed to detect conditions and obstacles behind the material handling vehicle 100. By way of some examples, the backward sensor 180, together with the controller 108, may sense various parameters corresponding to the surrounding environment and determine that the material handling vehicle 100 is approaching a pallet, an object, a person, or some environmental condition or hazard (e.g., a step, a stair, a dock door, etc.). In some examples, the backward sensor 180 may be mounted at a rear portion of the body 120.

The material handling vehicle 100 may further include one or more side sensors 190. Similar to the forward sensor 170 and the backward sensor 180, the side sensor 190 may be a data capture device such as an individual sensor or a collection of sensors, including, but not limited to, one or more cameras, laser scanners, accelerometers, gyro sensors, proximity sensors, radars, lidars, optical sensors (e.g., infrared sensors, photodiodes, image sensors, etc.), acoustic sensors, barometers, thermometers, and/or other suitable sensors. The side sensor 190 may similarly be communicatively, electrically, or otherwise connected to the controller 108.

The side sensor 190 may likewise be designed to detect conditions and obstacles beside the material handling vehicle 100. By way of some examples, the side sensor 190, together with the controller 108, may sense various parameters corresponding to the surrounding environment and determine that the material handling vehicle 100 is approaching a pallet, an object, a person, or some environmental condition or hazard (e.g., a step, a stair, a dock door, etc.). In some examples, the side sensor 190 may be mounted on one or both of a sides of the body 120. Some examples may utilize a plurality of side sensors 190 or mounting configurations to increase the viewing range and/or detection sensitivity of the side sensor 190. Some examples may provide sensor configurations and mounting locations to provide up to a 360° viewing range for the operator of the material handling vehicle 100. Accordingly, by way of example, the forward sensor 170, backward sensor 180, and the side sensor 190 may all be designed to detect aisles, racks, and barcodes on objects as a material handling vehicle 100 travels down an aisle.

A back rest 200 coupled to the mast 124 may further be provided with a load sensor 202. Similar to the forward sensor 170, the load sensor 202 may be provided in the form of one or more strain gauge load cells, hydraulic load cells, pneumatic load cells, capacitive load cells, piezoelectric transducers, and the like, or combinations thereof. Further, the load sensor 202 may be provided in the form of an individual sensor or a collection of sensors, including, but not limited to, one or more cameras, laser scanners, accelerometers, gyro sensors, proximity sensors, radars, lidars, optical sensors (e.g., infrared sensors, photodiodes, image sensors, etc.), acoustic sensors, barometers, thermometers, or other suitable sensors. The load sensor 202 may similarly be communicatively, electrically, or otherwise connected to the controller 108. The back rest 200 may also include an aiding device 204 that may be used to physically adjust a position of the load sensor 202. The aiding device 204 may help properly position the load sensor 202 for optimal efficiency.

The load sensor 202 may be designed to detect parameters relating to the load. By way of some examples, the load sensor 202, together with the controller 108, may sense various parameters corresponding to a load positioned on the forks 156a, 156b and/or parameters corresponding to the surrounding environment to determine whether a load is properly loaded onto the forks 156a, 156b, the balance of the load, and a distance of the load from the back rest 200. The load sensor 202, together with the controller 108, may further be designed to perform other functions such as identifying the type of load or determining a precise location of a pallet relative to the material handling vehicle 100.

In addition, the outer mast 150 may include a height sensor 210, which may be communicatively, electrically, and/or otherwise connected to the controller 108. The height sensor 210, together with the controller 108, may be used to determine a height of the forks 156a, 156b and to ensure proper balancing of the material handling vehicle 100.

A secondary display 220 may be provided near the operator’s seat 122. In an example, the secondary display 220 may be provided on the console 162. However, the exact location of the secondary display 220 may vary depending on the examples. The secondary display 220 may be coupled to the controller 108. The primary displays 104a, 104b and the secondary display 220 may be designed to show various data or images gathered or collected by the sensors onboard the material handling vehicle 100, such as the forward sensor 170, backward sensor 180, the side sensor 190, the load sensor 202, and the height sensor 210. The primary displays 104a, 104b and the secondary display 220 may be provided in the form of a liquid crystal display (LCD), an organic light-emitting diode (OLED) display, or other device configured to display data and images. The primary displays 104a, 104b and the secondary display 220 may further include an interface module, which may include one or more light emitting diode (LED) indicators or other icons, display configurations, indicators, and the like. The primary displays 104a, 104b and the secondary display 220 may also include, or otherwise be operatively connected to, a computing device or computer display. The interface module may include one or more displays or widgets for displaying the output of the processing module and associated post-processing methods described herein. The primary displays 104a, 104b and the secondary display 220 may also accept user input such that the data and output information may be manipulated, edited, or otherwise modified during the processing methods. The primary displays 104a, 104b and the secondary display 220 may also include one or more control devices for controlling the material handling vehicle 100 and individual subassemblies thereof. Although the primary displays 104a, 104b are shown as two separate displays, in some examples, the primary display may be provided in the form of a single display monitor.

The material handling vehicle 100 may further include additional controllers 230 in addition to the primary controller 108. The additional controllers 230 may be used to lighten the processing load of the controller 108. In an example, the controller 108 may be used for perception related operations, while the additional controllers 230 may be used for other operations such as load handling, navigation, balancing, or other suitable tasks. Depending on the examples, the additional controllers 230 may be omitted and the controller 108 may accomplish all the processing alone, or the processing may be distributed to remote servers for distributed computing.

It is to be appreciated that the material handling vehicle 100 may further include one or more additional sensors positioned at different locations on the material handling vehicle 100. Some of these additional sensors may include, for example, a weight sensor, a tilt angle sensor, balance sensors, and the like. These additional sensors may be positioned at appropriate locations on the material handling vehicle 100 depending on the circumstances, and be communicatively, electrically, or otherwise connected to the controller 108.

The primary displays 104a, 104band/or the secondary display 220 may also show parameters measured by the material handling vehicle 100 (e.g., mast height, load weight, fork tip alignment to target, pedestrian detection, speed, battery charge, etc.), vehicle data, error codes, emergency notifications, pedestrian identifications, etc. In some instances, one or more of the primary displays 104a, 104b is a heads-up display, frameless, and/or transparent. Further, the primary displays 104a, 104bmay be sized to be substantially the same width and height as the width and height of subcomponents of the mast 124. Thus, the primary displays 104a, 104b are configured to not cause more visual obstruction than the mast 124 itself.

It is to be understood that although FIG. 1 shows the material handling vehicle 100 as a counterbalance-type forklift truck, this is not to be considered limiting. The material handling vehicle 100 may be provided in the form of any material handling vehicle or other vehicle used to transport materials. For example, the material handling vehicle 100 may be provided in the form of a reach truck, a stacker, a pallet truck, or an order picker.

With reference to FIG. 2, in some instances, the field of view enhancement system 102 further includes a second blind spot camera 106b, a carriage camera 240, and an operator sensor 242 which are wired and/or wirelessly communicatively connected to the controller 108. In some instances, one or more of the first blind spot camera 106a and the second blind spot camera 106b are mounted to a first side surface 244a and a second side surface 244b of the mast 124. In some instances, one or more of the first blind spot camera 106a and the second blind spot camera 106b are mounted to a first front surface 246a and a second front surface 246b of the mast 124. The carriage camera 240 is also mounted to the mast 124 and provides a view of pallets to be transported by the material handling vehicle 100. In some aspects, the carriage camera 240 is height adjustable. Images from fork tip cameras 158a, 158band/or the carriage camera 240 may be shown picture-in-picture in the primary displays 104a, 104b and/or the secondary display 220.

In some forms, the picture-in-picture feature of the primary displays 104a, 104band/or the secondary display 220 changes in response to certain vehicle conditions. For example, when the material handling vehicle 100 is in neutral or is moving forward, the picture-in-picture feature may be inactive. When the material handling vehicle 100 is in reverse, the picture-in-picture may automatically show the live feed from the backward sensor 180 in instances where the backward sensor 180 includes a camera. In some forms, when the lift carriage 154 is extended upward past a height threshold value, the height-adjustable picture-in-picture display may show a live feed of one or more of the carriage camera 240 or the fork tip cameras 158a, 158b. In some forms, the picture-in-picture will move up and down on the primary displays 104a, 104b based on output from the height sensor 210. For example, the picture-in-picture may move up and down on the primary displays 104a, 104b in proportion to the movement of the forks 156a, 156b up and down the mast 124. The operator sensor 242 may be any type of sensor configured to detect the presence of an operator 248 in the seat 122 and/or a location of the operator’s eyes within a cab 250 of the material handling vehicle 100 (e.g., a camera, ultrasonic, infrared, pressure, presence, motion, etc.). The operator sensor 242 may be mounted within the cab 250. Further, the second blind spot camera 106bis forward-facing and has a second camera field of view 142b.

One or more of the first blind spot camera 106a, and the second blind spot camera 106b may be self-leveling and/or gimbaling via a first motor 260a, and a second motor 260b (e.g., stepper motors), respectively, to compensate for tilt (e.g., forward or backward) of the mast 124. The first motor 260a and the second motor 260b may be actuated according to signals from a tilt sensor 262 mounted to the mast 124. In some instances, the first blind spot camera 106a and the second blind spot camera 106b self-level once the mast 124 is placed in a tilt position and stops moving. In some instances, the first blind spot camera 106a and the second blind spot camera 106b self-level dynamically in real time as the mast 124 tilts. In some instances, the first and/or second blind spot cameras 106a, 106bself-level and/or angularly adjust relative to the mast 124 based on positioning of the seat 122 within the cab 250.

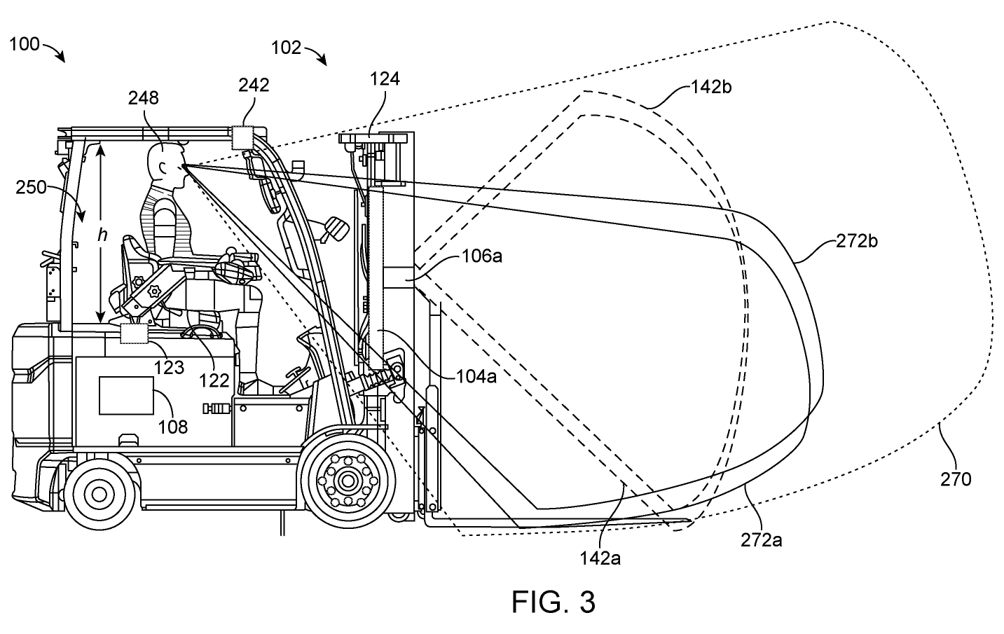

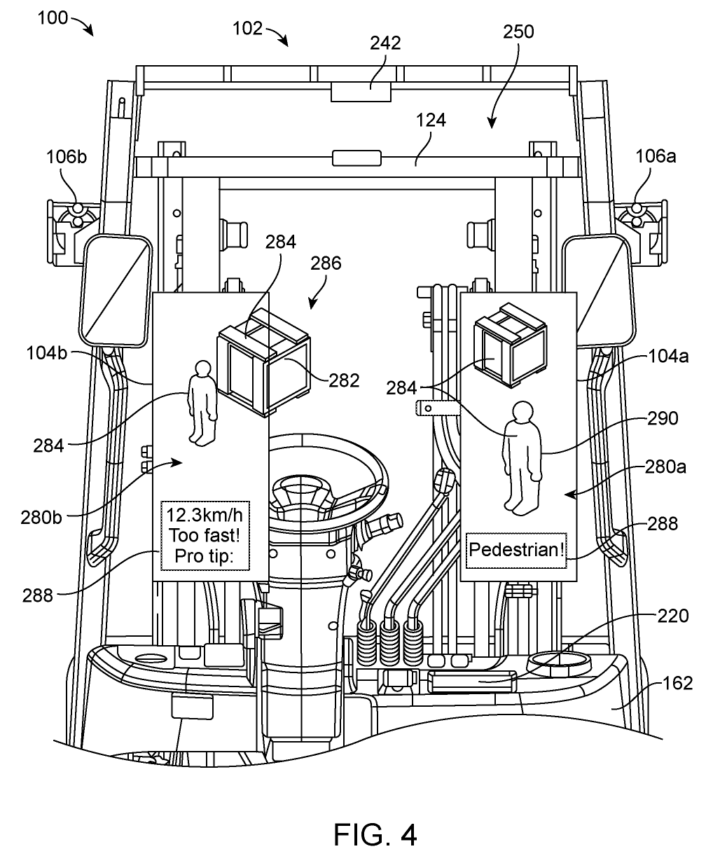

With reference to FIGS. 2 and 3, the operator 248 has an operator field of view 270, which is partially obscured by the mast 124, thus forming blind spots 272a, 272b. It should be understood that the operator field of view 270, the first camera field of view 142a, the second camera field of view 142b, and the blind spots 272a, 272b overlap one another horizontally (shown in FIG. 2) and vertically (shown in FIG. 3). Thus, image data from the first blind spot camera 106a and the second blind spot camera 106b (shown in FIG. 2) may be presented to the operator 248 via the primary display 104a and the primary display 104b (shown in FIG. 2) to compensate for and/or fill-in the blind spots 272a, 272b. The operator sensor 242 may also be configured to detect a height h of the operator 248 (shown in FIG. 3). In some examples, the height of the primary displays 104a, 104b, and/or the images 280a, 280b (shown in FIG. 4) are based, at least in part, on the detected height h of the operator. In some aspects, the size, height, and/or orientation of the primary displays 104a, 104b, and/or the images 280a, 280b may minimize operator fatigue.

It should also be understood that the operator field of view 270 differs in size and shape from the first camera field of view 142a and the second camera field of view 142b. These differences may be based on the height h of the operator 248, location of the operator’s 248 eyes within the cab 250, and/or placement of the first blind spot camera 106aand the second blind spot camera 106b along the mast 124. In some instances, the controller 108 adjusts the image data from the first blind spot camera 106a and the second blind spot camera 106b to compensate for the differences in size and shape between the operator field of view 270, the first camera field of view 142a, and the second camera field of view 142b. In some instances, the controller 108 uses operator data (e.g., height, eye location, etc.) from the operator sensor 242 and/or predetermined adjustment parameters to make these image adjustments. In some forms, an output from the operator presence system 123 triggers the operator sensor 242 to detect the height of the operator 248 and the location of the operator’s 248 eyes. Further, in some instances, the controller 108 adjusts positioning of the seat 122, and thus the location of the operator’s 248 eyes, within the cab 250 to compensate for the differences between the fields of view 270, 142a, 142b. In some instances, the controller 108 self-levels and/or angularly adjusts the first and/or second blind spot cameras 106a, 106b relative to the mast 124 to compensate for these field of view 270, 142a, 142b differences. Consequently, the field of view enhancement system 102 generates and presents an optical illusion for the operator 248 as if the mast 124 was not present and/or if the mast was transparent.

FIG. 4 illustrates a forward-looking interior view of the cab 250 as viewed by the operator 248 (shown in FIGS. 2 and 3). The field of view enhancement system 102 generates and presents images 280a, 280b from the first blind spot camera 106a and the second blind spot camera 106b via the primary displays 104a, 104b. Additionally, the controller 108 (shown in FIGS. 2 and 3) may adjust the images 280a, 280b by electronically cropping and/or zooming the image data supplied by the cameras 106a, 106b. In some instances, the operator 248 (shown in FIG. 3) may select, via the console 162, to have none, only one, or both of the primary displays 104a, 104b be active. In some instances, the operator 248 may selectively adjust the brightness, contrast, color intensity, etc. of the primary displays 104a, 104b via the console 162. In some instances, the displays 104a, 104b are motorized and thus tiltingly adjustable relative to the mast 124 via the console 162.

More specifically, the controller 108 may adjust the one or more images 280 with respect to the operator’s 248 perspective from the cab 250 and the operator field of view 270 (shown in FIGS. 2 and 3) such that the presented objects 284 and/or pedestrians shown in the primary displays 104a, 104b align with the actual objects 282 and/or pedestrians in a surrounding environment 286. For example, the size and shape of presented objects 284 shown in the display can be substantially similar to a size and shape of actual objects 282 as they would appear to the operator 248 if the operator 248 had an unobstructed view of the actual objects 282 in the environment 286. Thus, when the field of view enhancement system 102 is active, the primary displays 104a, 104b mimic transparent windows. Accordingly, the actual objects 282 and/or pedestrians that would otherwise be obscured by the mast 124 are visible to the operator 248. In some aspects, the one or more images 280 may include a visual representation of pallet pockets to assist an operator in determining a placement for the forks 156a, 156b for executing pickup tasks, to reduce the risk of damaging the fork tines or puncturing palletized goods. In some examples, the pallet pockets may be detected and estimated as visual representations using a pallet detection system. The pallet detection system may be provided in the form of a deep learning-based automated system for pallet and pallet pocket detection to aid in operator fork alignment. In some aspects, the pallet detection system may be designed to work in low-light environments.

Further, in some instances, the controller 108 adjusts the one or more images 280 according to field of view options selected by the operator 248 via the console 162. In some instances, the operator 248 may adjust the one or more images 280 in a manner similar to adjusting a mirror via the controller 108 and the console 162. In some instances, the controller 108 stops displaying the one or more images 280 when the mast 124 extends, retracts, and/or moves vertically. In some instances, the first and/or second displays 104a, 104b respectively show picture-in-picture images 288, activated feature(s), vehicle parameters (e.g., speed), operation suggestions, turn-by-turn directions, picking instructions, etc. Further, in some instances where the controller 108 detects that the material handling vehicle 100 is operating outside of one or more vehicle operation threshold values (e.g., speed, load, mast height, mast tilt, etc.), the picture-in-picture images may present warnings, alerts, micro-trainings, etc. Additionally, in some instances, the controller 108 displays contrastingly colored and/or highlighted outlines 290 superimposed around the presented objects 284 (e.g., the pedestrian(s) shown in FIG. 4). In some aspects, the one or more images 280 may be selectively triggered based on one or more criteria (e.g., no display except when a pedestrian is detected, or only display speed unless a pedestrian is detected, etc.). In some aspects, the display configurations can be customized via user input and/or via a computing device. In some instances, when a pedestrian is detected within a distance threshold, the controller 108 brakes the front wheels 126 and/or rear wheels 128 (shown in FIG. 1). In some examples, the system may be used to inform a pedestrian of dangerous loads on high shelves within the vicinity of where they are walking.

Additionally, in some instances, the controller 108 presents differing user interfaces based on operational modes (e.g., lifting, traveling, reversing, etc.) of the material handling vehicle 100 via the displays 104a, 104b, 220. For example, in a traveling mode, the controller 108 presents the images 280a, 280b to mimic transparent windows as described above. In a lifting mode, the controller 108 may present images 280a, 280b to show image data from the fork tip cameras 158a, 158b and/or the carriage camera 240 (shown in FIG. 2) to aid the operator 248 in retrieving or placing a pallet. Additionally, in the lifting mode, the controller 108 may detect engagement features (e.g., pockets, tabs, slats, etc.) of pallets based on image data from the fork tip cameras 158a, 158band/or the carriage camera 240. In some instances, the controller 108 may highlight these engagement features in the images 280a, 280b. In a reverse mode, the controller 108 may present images 280a, 280bto show image data from the backward sensor 180 while the material handling vehicle travels in reverse.

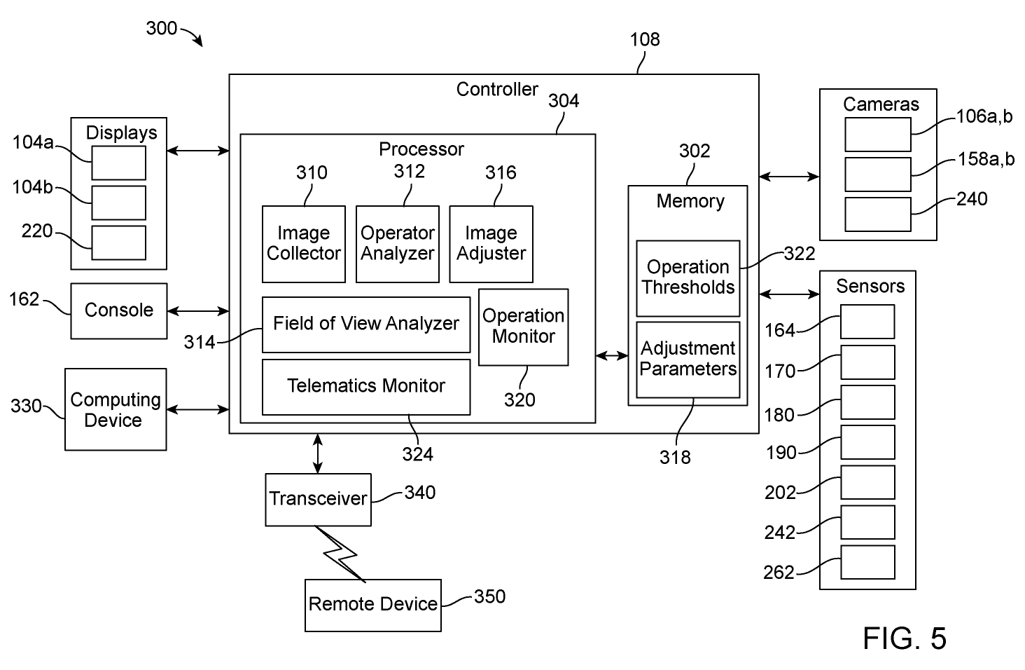

With reference to FIG. 5, electronic components 300 of the field of view enhancement system 102 (shown in FIG. 1) may be communicatively connected, wired or wirelessly, to one another for example, via CAN bus communication. The electronic components 300 include the primary displays 104a, 104b, the blind spot cameras 106a, 106b, the secondary display 220, the carriage camera 240, the console 162, and the sensors 164, 170, 180, 190, 202, 210, 242, 262 powered by and/or communicatively connected to the controller 108 (e.g., via Ethernet, CAN, a power over Ethernet (PoE) switch, etc.). The controller 108 may include memory 302 and a processor 304 (e.g., a graphics processing unit) and may implement an object detection protocol (e.g., YOLO), image adjustments, real-time object identification, augmented reality, simultaneous localization and mapping, object tracking, etc., using data from one or more of the blind spot cameras 106a, 106b, the carriage camera 240, the console 162, the forward sensor 170, the backward sensor 180, the side sensors 190, the operator sensor 242, and the tilt sensor 262. Further, when adjusting images, the controller 108 accounts for load and balance of the material handling vehicle 100 (shown in FIG. 1) using data from the load sensor 202, the height sensor 210, and the tilt sensor 262.

The processor 304 includes instructions to execute an image collector 310, an operator analyzer 312, a field of view analyzer 314, and an image adjuster 316. The processor 304 retrieves predetermined adjustment parameters 318 (e.g., crop and zoom offsets, image trapezoid offsets, operator height presets, etc.) stored in the memory 302. The processor 304 further includes instructions to execute an operation monitor 320 and retrieves operation thresholds 322 (e.g., speed, load mass, mast height, mast tilt, load stability, etc.) stored in the memory 302. The processor 304 further includes instructions to execute a telematics monitor 324.

Further, a user may selectively program (e.g., code, instruct, modify, etc.) the controller 108 via the console 162 and/or an accessory computing device 330. For example, the operator height h (shown in FIG. 3) may be entered into the memory 302 by the operator 248 via the console 162 and/or the accessory computing device 330. For the purpose of defining and describing the present disclosure, it is noted that the term “processor” generally means a device that executes functions according to machine-readable instructions or that has been configured to execute functions in a manner analogous to machine-readable instructions, such as an integrated circuit, a microchip, a computer, a central processing unit, a graphics processing unit, field-programmable gate array (FPGA), an application-specific integrated circuit (ASIC), or any other computation device. Additionally, it is noted that the term “memory,” as used herein, generally means one or more apparatus capable of storing data or machine-readable instructions for later retrieval, such as, but not limited to, RAM, ROM, flash memory, hard drives, or combinations thereof.

The controller 108 may be in further communication with a transceiver 340 configured to transmit and receive information to and from one or more remote devices 350 (e.g., other material handling devices, a central server, a handheld diagnostic tool, a smartphone, etc.).

The image collector 310 collects image data from the first blind spot camera 106a and the second blind spot camera 106b (shown in FIG. 3) and, in some instances, formats the image data for further analysis. In some instances, the operator analyzer 312 measures the height h of the operator 248 and locates the operator’s 248 eyes within the cab 250 (shown in FIG. 3).

The field of view analyzer 314 determines offsets between the operator field of view 270, the first camera field of view 142a, and the second camera field of view 142b (shown in FIG. 3). In some forms, the offsets from the field of view analyzer 314 are provided in the form of left or right distance values for which the images shown on the display will be zoomed in or cropped to adjust certain displayed objects to the left or right. In some instances, the field of view analyzer 314 analyzes relative features identified within one or more image frames from a collected image data set. The collected image data set may be analyzed to identify individual features or portions thereof based on a comparison of aspects of the features as they appear in multiple image frames as the material handling vehicle 100 (shown in FIG. 1) moves about a facility. An image frame of a particular object in the facility may have different visual representations in different frames, depending on the angles of the first blind spot camera 106a and the second blind spot camera 106b relative to the object as the material handling vehicle moves. The field of view analyzer 314 may use image processing, including one or more filters and contrast adjustments to identify features through one or more image frames to measure an optical flow and determine a speed, distance, location, and other parameters related to the movement of the material handling vehicle 100 through the facility.

The image adjuster 316 modifies the image data based on the results data of the operator analyzer 312 (e.g., operator height, eye location, etc.) and the field of view analyzer 314 (e.g., field of view offsets) and sends adjusted images to the primary displays 104a, 104b for presentation to the operator 248 (shown in FIG. 2).

The operation monitor 320 detects operation events where the material handling vehicle 100 is being operated and/or driven outside of the operation thresholds 322 and sends messages (e.g., warning, alerts, micro-trainings, etc.) to the primary displays 104a, 104b for presentation to the operator 248 (shown in FIG. 2). In one non-limiting example, the displays 104a, 104b may generate an instability warning based on detected parameters associated with the lift cylinders. In some examples, the displays 104a, 104b may generate a maintenance reminder, an error code, a setting visualization, an overload, a warning, or a combination thereof, based on one or more operating parameters.

The telematics monitor 324 tracks and/or logs movements of the material handling vehicle 100 and/or tasks performed by the mast 124. Thus, the telematics monitor 324 may record locations where the material handling vehicle 100 has delivered particular pallets (e.g., pallets that are particularly heavy and/or contain potentially hazardous contents). The telematics monitor 324 may then report these locations via the transceiver 340 and remote devices 350 (e.g., to pedestrians, other vehicle operators, etc.).

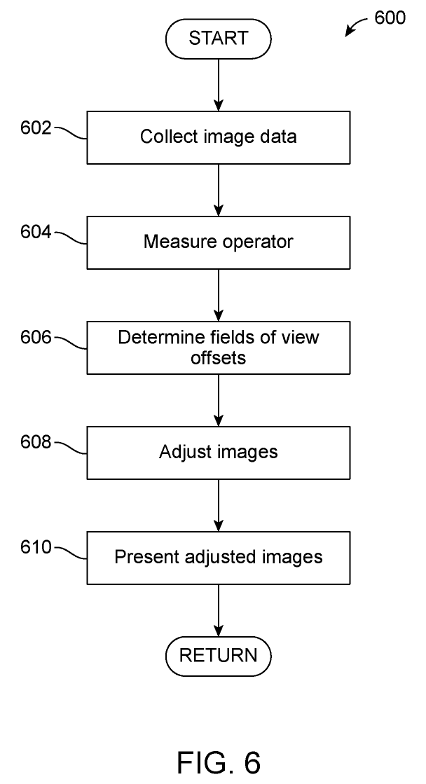

FIG. 6 illustrates a flow diagram depicting a method 600 executable by the controller 108 of FIG. 5 to mitigate operator blind spots. The method 600 starts at block 602, where the controller 108 collects image data. More specifically, the image collector 310 receives and formats an image data stream from the first blind spot camera 106a and the second blind spot camera 106b. The method 600 proceeds to block 604.

At block 604, the controller 108 measures the operator 248 of the material handling vehicle 100. More specifically, the operator analyzer 312 receives and analyzes data from the operator sensor 242 to determine a height h of the operator 248 and where the operator’s 248 eyes are located in the cab 250. The method 600 proceeds to block 606.

At block 606, the controller 108 determines field of view offsets. More specifically, the field of view analyzer 314 determines offsets between the operator field of view 270, the first camera field of view 142a, and the second camera field of view 142b. The method proceeds to block 608.

At block 608, the controller 108 adjusts images. More specifically, the image adjuster 316 modifies image data based on the results data of the operator analyzer 312 and the field of view analyzer 314. The method 600 proceeds to block 610.

At block 610, the controller 108 presents adjusted images. More specifically, the image adjuster 316 sends adjusted images to the primary displays 104a, 104b for presentation to the operator 248. The method 600 returns to block 602.

In other examples, other configurations are possible. For example, those of skill in the art will recognize, according to the principles and concepts disclosed herein, that various combinations, sub-combinations, and substitutions of the components discussed above may provide appropriate control for a variety of different configurations of material handling vehicles, work machines, operator control systems, and so on, for a variety of applications.

The previous description of the disclosed examples is provided to enable any person skilled in the art to make or use the disclosure. Various modifications to these examples will be readily apparent to those skilled in the art, and the generic principles defined herein may be applied to other examples without departing from the spirit or scope of the disclosure. Thus, the disclosure is not intended to be limited to the examples shown herein but is to be accorded the widest scope consistent with the principles and novel features disclosed herein.

What is claimed is:

1. A material handling vehicle, comprising:
a mast;
a display mounted to a rear side of the mast;
a camera in communication with the display; and
a controller in communication with the camera and the display, the controller including a processor and memory configured to display an image of an environment forward of the mast via the display.

2. The material handling vehicle of claim 1, wherein the processor and memory are configured to adjust the image to align with the environment with respect to a field of view of an operator such that a size and shape of presented objects shown in the display are substantially similar to a size and shape of actual objects as they would appear to the operator if the operator had an unobstructed view of the actual objects in the environment.

3. The material handling vehicle of claim 2, wherein the processor and memory adjust the image based on one or more of
an operator presence system output, and
a height of an operator seat.

4. The material handling vehicle of claim 3, wherein the processor and memory adjust the image based on relative features identified within a plurality of image frames collected from image data of the camera.

5. The material handling vehicle of claim 1, further comprising:
at least one camera motor, and
a tilt sensor to measure a tilt angle of the mast,
wherein the processor and memory are configured to level the camera via the at least one camera motor based on the tilt angle of the mast.

6. The material handling vehicle of claim 5, wherein the processor and memory are configured to level the camera after the mast is placed in a tilted position and stops moving.

7. The material handling vehicle of claim 5, wherein the processor and memory are configured to level the camera dynamically as the mast tilts.

8. The material handling vehicle of claim 1, wherein the processor and memory are configured to adjust the image based on a field of view offset value, wherein the field of view offset value is determined based on one or more of a height of an operator and a location of an eye of the operator relative to the mast.

9. The material handling vehicle of claim 8, wherein the processor and memory determine one or more of the height of the operator and the location of the eye of the operator via an operator sensor mounted within a cab.

10. The material handling vehicle of claim 8, wherein the field of view offset value includes one or more predetermined adjustment parameters including crop and zoom offsets, an image trapezoid offset, or operator height presets.

11. The material handling vehicle of claim 1, further comprising:
a carriage coupled to the mast; and
a carriage camera coupled to the carriage,
wherein the carriage further includes a pair of forks, each fork including a fork tip.

12. The material handling vehicle of claim 11, further comprising:
wherein the carriage camera is positioned one of between the pair of forks or in one of the fork tips.

13. The material handling vehicle of claim 11, wherein the display is configured to show a picture-in-picture video feed of the carriage camera.

14. The material handling vehicle of claim 1, wherein the display is configured to show a live feed of one or more material handling vehicle parameters such as mast height, load weight, fork tip alignment status, pedestrian detection status, and vehicle speed.

15. The material handling vehicle of claim 14, wherein the processor and memory store one or more vehicle operation threshold values and are configured to show an alert on the display when the one or more vehicle operation threshold values are exceeded.

16. A method to mitigate blind spots for an operator of a material handling vehicle, the method comprising:
collecting images from a camera mounted to the material handling vehicle, the camera being oriented to look forward relative to a mast of the material handling vehicle;
measuring one or more parameters of an operator aboard the material handling vehicle behind the mast;
determining field of view offsets based on the measured one or more parameters;
adjusting the images based on the field of view offsets; and
presenting the adjusted images on a display mounted to an operator side of the mast.

17. The method of claim 16, further comprising:
determining a tilt angle of the mast with a tilt sensor; and
leveling the camera with at least one camera motor based on the tilt angle.

18. The method of claim 16, wherein the one or more parameters include a height of the operator and a location of an eye of the operator.

19. A material handling vehicle, comprising:
a mast;
a display mounted to a rear side of the mast;
an operator station behind the mast and the display;
a camera in communication with the display; and
a controller in communication with the camera and the display, the controller including a processor and memory configured to:
adjust an image from the camera of an environment forward of the mast, and
display the adjusted image via the display, the adjusted image providing an optical illusion to an operator seated in the operator station that the mast is transparent.

20. The material handling vehicle of claim 19, wherein the processor and memory are configured to adjust the image based on one or more of a height of the operator, a location of an eye of the operator relative to the mast, and a field of view offset value.
